(19) United States
(12) Patent Application Publication
(10) Pub. No.: US 2002/0131075 A1
(43) Pub. Date: Sep. 19, 2002

(54) Tab modification system for a printing machine

(75) Inventor: Karl Heinz Kremer, Rochester, NY (US)

Correspondence Address: Gustavo Siller, Jr., c/o BRINKS HOFER GILSON & LIONE, P.O. Box 10395, Chicago, IL, 60610-0395, US

(73) Assignee: Heidelberg Digital L.L.C..

(21) Appl. No.: 10/075,680

(22) Filed: Feb. 14, 2002

Related U.S. Application Data
(63) Continuation-in-part of application No. 09/754,562, filed on Jan. 4, 2001.
(63) Continuation-in-part of application No. 09/572,420, filed on May 17, 2000.

(51) Int. Cl. G06K 15/02; G06F 15/00; G06F 3/12; G06F 17/00; G06F 13/00

(52) U.S. Cl. 358/1.15; 358/1.9; 707/527; 358/1.18

(57) ABSTRACT

Information associated with a table of tabs is scanned into the memory of the job preparation station. Responsive to the information associated with the table of tabs, the job preparation station is able to modify this information. In one aspect, there is a method for modifying at least one document in a printing machine having a display device. The printing machine is able to determine a location of at least one marker on the at least one document. The printing machine is able to display the location of the at least one marker on the display device. The printing machine is also able to modify the at least one marker. At least one modified document is generated in response to the modified at least one marker.

This application is a continuation in part of U.S. patent application Ser. No. 09/754,562, entitled “Late Binding of Tab Image Contents to Ordered Tab Stock,” filed on Jan. 1, 2001, which is incorporated herein by reference. In addition, the aforementioned application is a continuation in part of U.S. patent applicant Ser. No. 09/572,420, entitled “Flexible Job Delivery for Job Preparation” filed on Aug. 15, 2000, which is also incorporated herein by reference.

### FIELD OF THE INVENTION

This invention relates generally to the field of printing machines, in particular for a print production device that is designed to improve the production of documents.

### BACKGROUND

While just about every computer user owns their own printer and is capable of producing high quality documents, the ability to produce such documents in high volume and with special finishing features, such as binding, is still within the purview of the commercial print shops and corporate copy departments. High volume, finished production of documents is typically referred to as production printing. A production printer is a printing device capable of rapid production of large volumes of documents. Typically these printers have high paper handling capacity, the ability to draw on multiple media types from multiple sources and the ability to automatically finish a document such as by adding a binding. Despite the automation provided by the production printer and the proliferation of computer technology, especially in the area of desktop publishing, production printing is still a complicated and often manual process.

In a typical print shop, customers bring in original documents, which they want turned into a finished product such as a bound booklet, a tri-fold brochure or a tabbed three ring bound notebook. In addition, they typically need a large volume of the finished product, for example, one thousand brochures. The combination of the original documents plus the instructions for producing the finished product is called a “job”. The documents can be brought in either in hard copy or electronic form, such as on floppy disk, compact disc or tape or can be transmitted to the print shop over a network such as the Internet.

After handing over the documents to the clerk, the customer relays his instructions for preparing the finished product. The clerk will note these instructions on a “ticket” or “job ticket”. The job ticket is typically a piece of paper with all of the instructions written on it for producing the finished product. As mentioned above, this is known as a job. The job will then be handed to an operator, who runs the production printer, to produce the finished output. The operator's job is to prepare the document for production, load the appropriate materials, such as paper stock and binding materials, into the production printer and ensure that the finished output is correct.

Many jobs have complicated print production requirements. The job may require the operator to modify the document or documents as a whole. The customer may want the operator to move or shift chapters, sections or portions of the documents. In addition, these portions of the documents may contain regular tabs and bleed tabs that are also shifted or moved around by the operator. Often, when the portions of the document are shifted or moved, the regular tabs and the bleed tabs also are moved, so the tabs of the document now are in disarray or out of order. Thus, the tabs of moved or shifted pages of a document may be in the wrong place and may have the wrong tab information.

### SUMMARY

The present invention is defined by the following claims, and nothing in this section should be taken as a limitation on those claims.

Information associated with a table of tabs is scanned into the memory of the job preparation station. Responsive to the information associated with the table of tabs, the job preparation station is able to modify this information.

In one aspect, there is a method for modifying at least one document in a printing machine having a display device. The printing machine is able to determine a location of at least one marker on the at least one document. The printing machine is able to display the location of the at least one marker on the display device. The printing machine is also able to modify the at least one marker.

In another aspect, there is a method for modifying documents in a printing machine having a display device. The printing machine is able to determine a location of at least one first marker on a first document. The printing machine is able to determine a location of at least one second marker on a second document. The printing machine is able to display the location of the at least one first and at least one second markers on the display device. The printing machine is able to modify the at least one first and at least one second markers.

In yet another aspect, there is a printing machine. The printing machine includes a job preparation station that comprises a display device having a viewer component and a desktop component. The viewer component is configured to display at least one document. The desktop component is configured to determine a location of at least one marker on the at least one document. The viewer component is configured to display the location of the at least one marker. The desktop component is configured to modify the at least one marker.

In yet another aspect, there is a printing system for printing a plurality of printing jobs. The printing system comprises a plurality of job preparation stations, a job allocator. Each of the job preparation stations a respective operator receives at least one document to be printed, converts the at least one document into ready for printer file format, and generates an electronic job ticket representing global document features, each job preparation station having a set of defined station attributes. The job allocator that receives the set of defined station attributes of the job preparation stations and distributes printing jobs to a selected one of the job printing stations based on the defined station attributes of all of the job preparation stations. The job preparations stations also comprise a display device having a viewer component and a desktop component. The viewer component is configured to display at least one document. The desktop component is configured to determine a location of at least one marker on the at least one document. The viewer component is configured to display the location of the at least one marker. The desktop component is configured to modify the at least one marker. The printing system also includes an output device connected to the job preparation stations, wherein the output device is operable to output the modified at least one marker on the at least one document.

### BRIEF DESCRIPTION OF THE DRAWINGS

FIG. 1 depicts a flow diagram illustrating a preferred production printing workflow;

FIG. 2 depicts a flow diagram showing the user functionality workflow of the preferred embodiment;

FIG. 3 depicts a representation of a graphic user interface display according to the preferred embodiment;

FIG. 4 depicts a visual representation of a document on a viewer component;

FIGS. 5A and 5B depict a flow-chart representation of the pagination tab process; and

FIG. 6 depicts two visual representation of an example of the pagination tab process.

### DETAILED DESCRIPTION OF THE PREFERRED EMBODIMENT

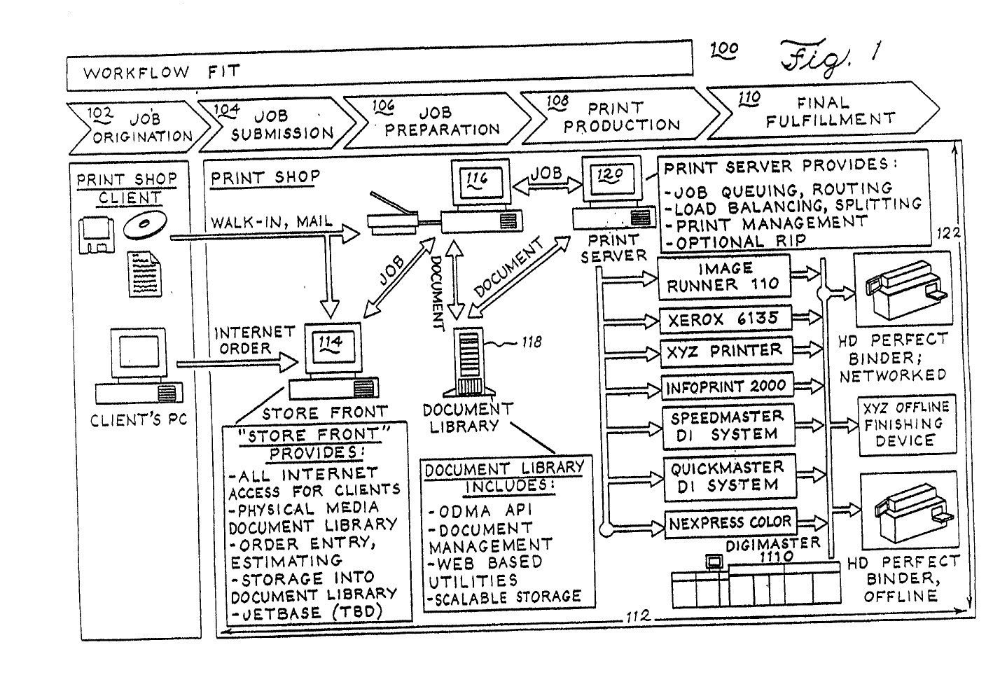

In order to have a better appreciation of the present invention, a discussion of the production flow in a production print shop is provided here. Referring now to FIG. 1, there is shown a flow diagram illustrating the production workflow 100 in a typical production print shop such as a commercial high volume copy or print shop. A workflow is defined as the tasks, procedural steps, organizations or people involved, required input and output information, and tools needed for each step in a business process. As will be discussed below, a workflow approach to analyzing and managing a business or process such as production printing can be combined with an object oriented approach, which tends to focus on the discrete objects and processes involved such as documents, pages, data and databases. For the purposes of this disclosure, the term “object oriented”, when applied to the disclosed embodiments, does not imply that an object oriented programming approach is the only method of implementation of the disclosed embodiments.

FIG. 1 further depicts a typical computer network 112 for use in a print shop.

In a typical digital print shop, there will be a network 112 of computer workstations 114, 116, servers 118, 120 and high volume output devices 122 which make up the computer network 112. The servers 118, 120 include network servers 118 and print servers 120. The topology of the network 112 is typically structured so as to align with the workflow 100 of the print shop. The network 112 may be implemented as a wired or wireless Ethernet network or other form or local area network. Further, the network 112 may include wired or wireless connections to wide area networks such as the Internet and connections to other local area networks such as through a virtual private network.

The production workflow 100 includes the procedural stages of job origination 102, job submission 104, job preparation 106, print production 108 and final fulfillment 110. Alternatively, one or more of these procedural stages may be combined as well as there may be other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. Note that a job may contain more than one document and more than one set of instructions. For example, a job may contain many documents, each being one chapter of a book, along with a document containing a cover for the book. This exemplary job may include the instructions for producing the body of the book from the individual chapter documents and another set of instructions for producing the cover. In addition, as will be discussed below, there may be a third set of instructions for assembling the cover to the body of the book.

Job submission 104 is the receipt of the job by the print shop and the entering of the job into the print shops production system or workflow. Typically the instructions from the customer will be written down on a special form, known as a “ticket” or “job ticket”. A ticket may also be electronically created and maintained. Furthermore, pre-defined tickets may be available for standardized instructions. For example, the shop may have a pad of pre-printed tickets with the instructions to duplicate the documents, three-hole punch the final output and assemble the punched final output in a three ring binder. If this is a common request by customers, such pre-printed tickets can save time and resources. All the order-taking clerk need do is fill in any customer specific details such as the number of copies to produce. Pre-defined tickets may help to standardize operations and prevent errors in the transcription of instructions from the customer. In very simple print shops, job submission 104 may simply be the receiving of the original documents and instructions along with the creation of a ticket, placing the job in a paper folder and setting it in a physical queue for later handling in subsequent procedural stages.

In print shops, which handle jobs electronically, job submission 104 requires entering the job into the shops electronic production system. For documents that are brought in by the customer as hard copy, the documents must first be scanned electronically into the shop's computer system. For documents delivered in electronic form, the document data files must be loaded on the shop's computer system.

For the job submission stage 104, the computer network 112 will include one or more “store front” workstations 114. The store front workstations 114 are computer systems placed at the order taking desk, at a manned clerk's station or set out for customer self service use. These workstations 114 are used for the job submission stage 104 and typically will be configured to handle many different electronic media types such as floppy disk, compact disc, tape, etc. These stations 114 may also be configured to receive jobs over the Internet or other form of network connection with customers. Further, these workstations 114 are typically configured to read many different electronic file formats such as those used by the Microsoft Office™ family of products manufactured by Microsoft Corporation, located in Redmond, Wash. or various other desktop publishing program file formats such as Aldus Pagemaker™ or Quark Express™. In addition, these stations 114 can also read “ready for printer” file formats, which will be discussed later, such as Portable Document Format™(“PDF”), Postscript™(“PS”) or printer control language (“PCL”). Job preparation stations 114 can also accept image formats such as Tagged Image File Format (“TIFF”), bitmap (“BMP”) and PCX. These stations 114 may also include a scanner 116 for scanning hard copies of documents into the computer system. Scanners typically are complicated devices to operate and some print shops may prefer to locate the scanners in the job preparation stage 106 for use solely by trained personnel as will be discussed below. In addition, the store front computers 114 also provide the ability to generate a ticket, electronically or in hard copy form, for the job containing all of the instructions for completing the production printing task. This process of generating the ticket may be automated, involving pre-defined tickets, manual or a combination thereof, and is discussed in more detail below.

Job preparation 106 involves preparing the documents for printing according to the instructions in the ticket. For documents that are submitted in hard copy form, job preparation 106 may include scanning the documents and creating a faithful and error free electronic reproduction. The documents, once in electronic form, must also be distilled down or converted into a common file format that the print shop can use to both edit and print the documents. This alleviates the need for operators to deal with multiple different programs and eliminates the need to assemble complex documents together for printing using different electronic file formats.

For example, a customer may bring in two different documents, one being the body of a book and the other being the photographs to be inserted at specific pages. The customer may then instruct that the photographs be inserted at particular pages and that the final assembly has continuous page numbers added. The body of the book may be in Microsoft Word™ format while the images of the photographs are in Adobe Photoshop™ format. While the operator could figure out at which pages the images will be inserted and appropriately number the pages of the book and photographs using each individual software package, this is a very complex and time-consuming process. It also requires that the operator be trained and familiar with a range of software packages and runs the risk that he will not be familiar with the particular package that the customer used. Therefore, it is more efficient to distill each of the various file formats into a unified format that allows the operator to prepare the job using a single software interface. In the preferred embodiments, all documents, whether provided in hard copy or electronically, are distilled or converted into a “ready for printer” or “print ready” file format. In the preferred embodiments, the Portable Document Format™ is used as the ready for printer format, developed by Adobe Systems, Inc., located in San Jose, Calif.

A ready for printer file format is defined as a file format which contains both the data to be printed along with printer control instructions that can be directly interpreted by the internal processing engine of a printer or other form of hard copy output device in order to rasterize the data image onto the output media. Rasterization is the placement of image data at a specific location on the output media. Such file formats include Portable Document Format™(“PDF”) and Postscript™(“PS”) both manufactured by Adobe Systems, Inc., located in San Jose, Calif., as well as printer control language (“PCL”), manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the Tagged Image File Format (“TIFF”) contain bit image data only which is already in a format which specifies its output location on the output media and does not contain printer control instructions for interpretation by the internal processing engine of the printer and therefore, for the purposes of this disclosure, is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the operator's expectations.

For the job preparation stage 106, the computer network 106 includes job preparation stations 116 and network servers 118 coupled with the storefront workstations 114 over the network 112. Herein, the phrase “coupled with” is defined to mean directly connected to or indirectly connected with through one or more intermediate components. Such intermediate components may include both hardware and software based components. The job preparation stations 116 preferably execute workflow management software, described in more detail below, which allows the operator to manage, edit and print jobs. The network server(s) 118 includes a document library which allows manipulation, management, storage and archiving of jobs, or just there respective documents and/or tickets, as well as facilitates and manages the flow of jobs from the store front computers 114 to the job preparation stations 116 and from the job preparation stations 116 to the print servers 120 or the production output devices 122. Exemplary document libraries include Intra.Doc™ document management system manufactured by Intranet Solutions, Inc., located in Eden Prairie, Minn. and the DOCFusion document management system manufactured by Hummingbird, Inc., located in York, Ontario, Canada. In the preferred embodiment, the job preparation stations 116 are Imagesmar™ Workstations, manufactured by Heidelberg Digital, L.L.C., located in Rochester, N.Y. Alternatively, an appropriate computer hardware platform such as that comprising a Pentium™ class processor or better, manufactured by Intel Corporation, located in Santa Clara, Calif., 64 megabytes of RAM or more, a 20 gigabyte hard disk or larger and appropriate display device may be used. Further, in the preferred embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, bates numbering, adjusting page layout for tab stock and aligning the output to account for binding. Further, the job preparation stations 114 provide the capability to fix errors in the documents such as removing artifacts in scanned images and masking over unwanted text or markings. The job preparation stations 114 can also be used to prevent inaccuracies in the finished output caused by the printing or binding process. Such inaccuracies include binder's creep, which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep is prevented by shifting image slightly when performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet, also known as “n-up” to create proof sets, brochures or pamphlets, etc. Further, the job preparation station 116 permits the operator to add annotations to the document such as bates numbers, page numbers, logos and watermarks. All of these service add value to the final output. Formatting and other modifications to the document can be globally applied to the entire document, such as a shifted margin or may be applied only to select pages. Such alterations to the document are known as document/page features or attributes. Further, these alterations are also known as document or page exceptions since they typically override specific instances of the original document formatting as set by the customer.

The next stage in the print production workflow 100 is the print production stage 108. In the print production stage 108, the final form of the documents for printing is sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIP'ing the job, prior to sending it to a particular device 122. RIP stands for Raster Image Processor and is the hardware and/or software that converts ready for printer data into raster images. It is also a common term for rasterizing a page image on to the output media.

The print server 120 used in the print production stage 108 is coupled with the job preparation stations 116 and the network server 118 over the network 112. Further, the print server 120 is coupled with the various output devices 122 in the print shop. Note that some output devices 122 may not support electronic transfer of the data to be output and may require a manual step for operation. Such devices may include a special binding machine that requires that the partially finished documents be manually transferred to the binding machine to complete the production. The print server 120 is preferably implemented as a separate computer coupled with the network 112, however, software based print servers running on a network server 118, job preparation station 116 or store front workstation 114 may also be used. In the preferred embodiment, the printer server 120 includes an independent computer workstation, typically running a UNIX or Windows NT operating system, a software print server engine and a software print server application. The print server application offers the user interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary output devices include the Digimaster™ Digital High Volume Printer manufactured by Heidelberg Digital, L.L.C., located in Rochester, N.Y. and the NexPress™ Color printer manufactured by NexPress, Corporation, located in Rochester, N.Y.

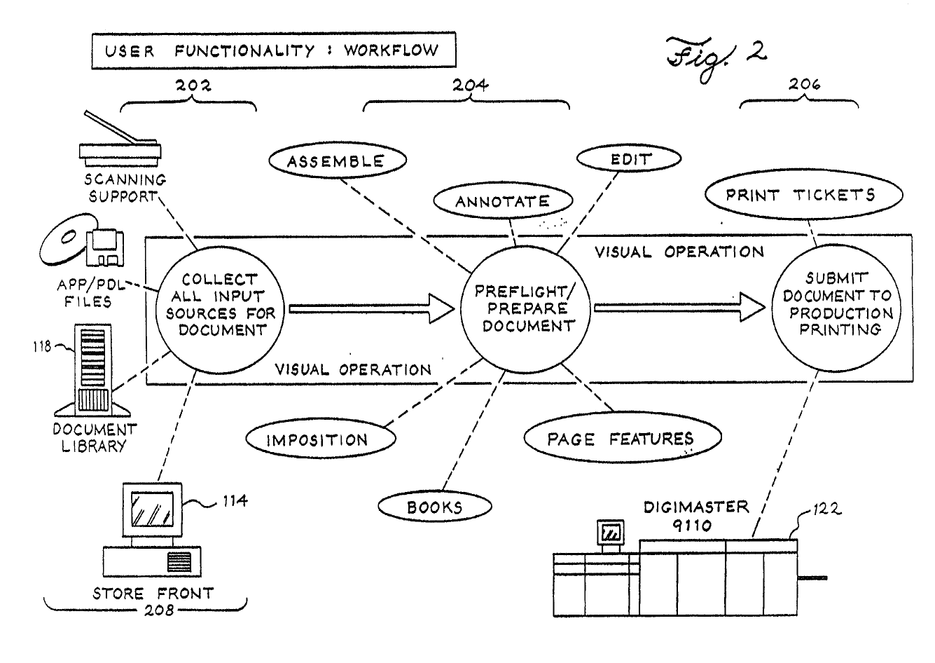

Referring now to FIG. 2, there is shown a flow diagram showing the user functionality workflow 200 of the preferred embodiment job submission and preparation stages 104, 106. The user workflow 200 includes an input source stage 202, a preflight stage 204 and a production stage 206. In the input source stage 202, all of the documents of the job are collected together from the different input sources 208. As detailed above, all of the collected documents are converted to a ready for printer format, preferably a Portable Document Format™. This conversion can be a manual or automated process or a combination thereof. For example, a special directory can be created on the network server 118 where data files in various file formats can be placed, for example, by the clerk who accepts the documents from the customer and inputs them into the store front workstation 114. Automated logic, which watches this directory, will see the placement of files and automatically convert them (or flag them for manual conversion) into a ready for printer format. Any documents that the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process may include a manual or automated determination of the capabilities, skill level or training level of the various operators currently logged into the available job preparation stations 116 as well as the current load/backlog of job in their respective queues. Taking these factors into account, job can be automatically or manually routed to the operator best able to handle the job both technically and in an expedient manner. This functionality can be implemented by creating an operator database which tracks the capabilities, skill level and training level of the various operators who work in the print shop. This database can be coupled with queue management software, which balances the loads/backlogs of job at each station 116.

In the preflight stage 204, the documents can be assembled, such as in a book, annotated, edited, and have imposition or other page features applied. Once the documents are prepared for production, they are passed to the production stage 206. In the production stage 206, the prepared documents along with the production instructions (from the tickets) are submitted to the print server or directly to the production output device 122 using a file downloader such as the Print File Downloader™ application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

In the preferred embodiments, the user functionality workflow is preferably implemented as a workflow management software program and interface executing on the job preparation workstation 116. The preferred workflow management software is visually oriented using an object oriented graphic user interface (“GUI”) approach that integrates control of the workflow functionality in a single interface. While the visual and operational appearance of the management software is object oriented, the implementation of the software may be by an object oriented programming language or a non-object oriented programming language as are known in the art.

In the GUI interface, documents, tickets and other entities and operations (collectively “objects”) are visually represented on the workstation 116 display, such as with icons, tree structures and pull-down menus, and may be interacted with using known devices and methods such as utilizing a mouse or track ball to control a visually represented pointing device which is then used to click, select, drag and drop the displayed representations. Such manipulation of the visual representations results in manipulation of the underlying objects (documents, tickets, and other entities and operations). Furthermore, the GUI also permits creation and manipulation of relationships and associations among the various objects and visually displays such relationships and associations. Relationships and associations may be displayed, for example, using a hierarchical approach like a tree structure or file folder structure or using some alternate form of visual indication. It will be appreciated that graphic user interfaces are well known in the art and that there are many software development packages available, which can be used to develop a GUI. One such package is the Open Software Development Kit available from Microsoft Corporation, located in Redmond, Wash.

Further, the preferred GUI utilizes a document centric approach providing a centralized viewing window for viewing documents being worked on. In the preferred embodiment, the document viewing functionality is provided by the Adobe Acrobat software program, manufactured by Adobe Systems, Inc., located in San Jose, Calif.

As was noted above, the workflow management software integrates applications that implement, control or manage the stages of the production printing workflow 100. These applications include inputting documents from various sources, document assembly including the creation and manipulation of books, document editing, document annotation, document library access on the network server 118, setting and manipulation of page features, creation and manipulation of job tickets and printing.

The workflow management software is capable of receiving input from various different sources. Such sources include hard copy originals input via a scanner, native application formats such as the Microsoft Office™ Product suite and desktop publishing applications such as Quark Xpress™, manufactured by Quark. Inc., located in Denver, Colo. and FrameMaker™, manufactured by Adobe Systems, Inc., located in San Jose, Calif. Further, the software can accept Tagged Image File Format (“TIFF”) documents as well as documents already in a ready for printer format such as PDF, PS or PCL. For hard copy input via a scanner, the software supports industry standard scanner interfaces, TWAIN, as defined by the TWAIN group located in Boulder Creek, Calif. and the Image and Scanner Interface Specification (“ISIS”) developed by Pixel Translations, Inc., located in San Jose, Calif. and also specified via American National Standards Institute specification ANSI/AIIM MS61-1996. Using these standard interfaces, the workflow management software receives the scanned image data directly in the ready for printer format. An exemplary scanner for use with the preferred workflow software is the Imagedirect™ Scanner manufactured by Heidelberg Digital, L.L.C., located in Rochester, N.Y.

The preferred workflow management software also provides ODMA support for interfacing with document libraries. In addition, the provided ODMA support further extends the functionality of the document library to handle management, storage and archiving of compound documents (described below) and tickets. This allows libraries of standardized tickets to be created or facilitates updates and reprints of compound documents such as books.

Once documents are loaded into the workflow management software, tools are provided to perform value added services and prepare the documents for production. Assembly is the process of arranging or rearranging pages or adding or removing pages within a document. Assembly also includes imposition where page positions are forced such as when the first page of a chapter is forced to the front side of the paper. The workflow management software provides cut, copy, paste and move functionality operable on 1 or more pages. This functionality is preferably implemented via pull-down menus, pop up dialog boxes or on screen option palates or buttons as provide by the graphic user interface. In addition, the results of the respective operations are shown in a visual representation of the document in the centralized document-viewing window on the job preparation station 116 display.

The workflow management software further provides support for editing and annotating the document. Tools are provided for image object area editing of a scanned page including erase inside and outside an area, cut, move, copy and paste area as well as pencil erase. Page editing tools are also provided for editing on one or more pages including area masking and cropping. Tools are also provided for annotating documents including alpha-numeric and graphic annotations. Exemplary annotations include page numbering and bates stamping. The tools further provide for placing images behind the document content, also known as watermarking. Annotation can be performed on any portion of one or more pages. For alpha-numeric annotations, the font size and style are controllable. In all cases, the results of the respective operations are shown in a visual representation of the document in the centralized document viewing window on the job preparation station 116 display. In the preferred embodiments, edits or annotations can be created or manipulated by pointing to a visual representation of the document and/or pages within the document and selecting, dragging, dropping or clicking the representation and/or selecting from a menu of options, where the selection of a particular option causes the associated edit or annotation to be applied to the specified portions of the document. Alternatively, a palate of options may be displayed from which the user may choose an option to apply to selected portions of the document. Further, the interface may provide for a dialog box or other visual control for inputting control values for the edit or annotation such as the starting number of a bates range.

The workflow management software preferably provides further support for compound documents that are documents comprised of one or more other documents, such as books comprised of chapters or course packs comprised of one or more excerpted sources . Compound documents take advantage of the object oriented nature of the workflow management software. A compound document (“CD”) is a collection of one or more documents which have a particular ordering to them such as the chapters of a book. The CD further contains an automatically generated assembled document which is a single document containing the whole assembled CD. Tools are provided which allow simple management of the documents of a CD, assembly and updating of the documents into the assembled document and selective document manipulation, such as selective printing, of the documents within the CD. Tools are also provided which can interpret the content of the documents within the CD and automatically generate a table of tabs in the assembled document. A compound document otherwise acts just like a document and can be edited, annotated, etc. and have tickets associated with it. Further, a compound document can contain other compound documents such as in the case of a multi-volume book. The individual documents and compound documents within the compound document further retain their independent existence and can be edited or printed independently of the CD and shared with other CD's with those edits being either automatically or manually updated into the assembled document within a particular CD. The workflow management software further displays a visual representation, such as with a hierarchical or tree structure, showing the compound document and any associated documents and tickets. In the preferred embodiments, compound documents can be created or manipulated by pointing to the visual representations of one or more documents and/or a visual representation of a CD and selecting, dragging, dropping or clicking and/or selecting from a menu of options, where the selection of a particular option causes the associated feature to be applied to the selected documents or compound documents. Alternatively, a palate of options may be displayed from which the user may choose an option to apply to selected compound documents. Further, the interface may provide for a dialog box or other visual control for inputting control values for the compound documents such as margin values. For example, a user may select one or more documents and then choose a create CD option from a pull down menu. The workflow software then creates a visual representation of the CD on the display showing the association of the CD to the selected documents. Alternatively, the user may first create a visual representation of a CD and then drag and drop the visual representations of one or more documents onto the CD visual representation. The workflow software then creates the appropriate logical associations of the data for which the visual representations represent.

The workflow management software is also preferably programmed with data about the different production output devices 122 in the print shop or otherwise available and their capabilities or other equipment, such as finishing equipment, which can be utilized either automatically or manually. The software provides tools which allow the operator to set page features/formatting which are made possible by those specific capabilities. Such page features include the plex of the document such as duplex or simplex (double sided or single sided output), binding options, such as stapling or hole punching and the availability and control settings for handling tab stock or ordered media. The preferred embodiments preferably support all of the features of the Digimaster™ line of high volume digital printers manufactured by Heidelberg Digital, L.L.C. located in Rochester, N.Y. In the preferred embodiments, these page features can be set by selecting or pointing to a visual representation of one or more pages and selecting from a menu of options, where the selection of a particular option causes the associated feature to be applied to the selected pages. Alternatively, a palate of options may be displayed from which the user may choose an option to apply to selected pages. Further, the interface may provide for a dialog box or other visual control for inputting control values for the feature such as the type of tab stock. Setting page features for specific pages encodes instructions to the production output device 122 for implementing those features within the ready for printer formatted file. When the production output device 122 receives the file for printing, it will interpret those instructions to implement the desired feature. For page features that the current device 122 cannot handle, the device 122 can signal the operator that manual intervention is required and direct the operator through the appropriate steps to implement the page feature and complete the job. This may include instructing the operator to remove partially finished documents and transfer them to a binding machine for finishing or instructing the operator to load a specific media type or tab stock into the device 122.

Tools are further provided by the workflow management software to support electronic versions of tickets for specifying production output device instructions and parameters, as well as other finishing steps which may or may not be automated, which are global to the document, e.g. job level features or global document attributes. These include such attributes as the general media type or color to use and the method of binding such as stapling. Tickets, also referred to as print tickets or job tickets, can exist independently of documents or compound documents as was mentioned above. They are independently visually represented on the display by the workflow management software. Tools are provided for manipulating tickets, such as saving, storing and associating them with documents or compound documents in addition to editing their options. In the preferred embodiments, tickets can be manipulated just like documents, using pointing, clicking, selecting, dragging and dropping. For example, a ticket can be associated with a document by selecting the ticket and dragging and dropping it on a particular document. The workflow management software then preferably visually displays the association by showing the ticket under the hierarchy of the document. Once associated, the options set by the ticket will apply to the associated document or compound document. The options represented by the ticket may be set by selecting the ticket to bring up a dialog box or pull down option menu, which displays the available options and allows modification of the option values. Tickets associated with documents can be manipulated with the document. For example, saving a document save all of its associated tickets. Furthermore, the workflow management software provides the capabilities to create libraries of standardized tickets, which can be used, for example, to standardize procedures across multiple franchised print shops.

Finally, the workflow management software provides tools to send the prepared documents and any associated tickets to the production output device for final production. In the preferred embodiments, documents or compound documents can be sent to a production output device by selecting, clicking or dragging the visual representation of the document or compound document to a visual representation of the print server or output device. Alternatively, the user may select an appropriate option from a pull-down menu, pop up dialog box or button palate. The workflow management software supports standard interfaces and protocols to production output devices and print servers. Further, tools are provided for managing, selecting and monitoring multiple production output devices. These tools provide visual feed back of each of the devices status to the user such as the current job queues.

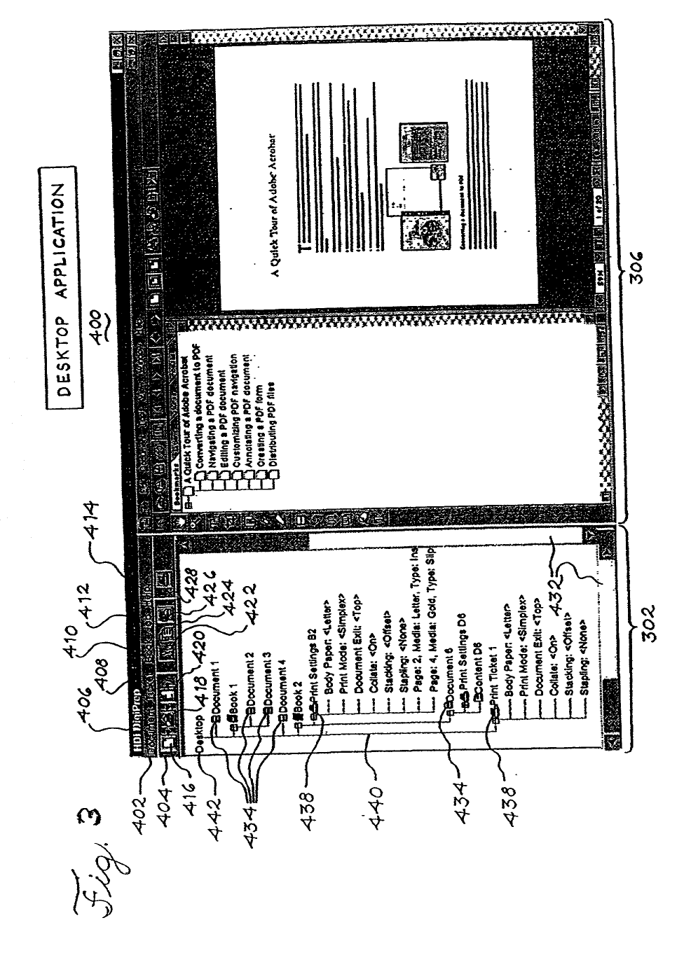

Referring now to FIG. 3, there is shown a representation of a graphic user interface display 400 according to the preferred embodiment. The display 400 includes viewer 306 and desktop 302 components. The desktop component 302 includes menus 402 and button palates 404 which allow the user to visually manage and manipulate the various objects described above. The menus 402 include a document menu 406, a ticket menu 408, a book menu 410, a job menu 412 and a help menu 414. The button palate 404 includes a new object button 416, an open button 418 and a library access button 420. The button palate 404 further includes a cut button 422, a copy button 424, a paste button 426 and a print button 428. It will be appreciated that graphic user interfaces are well known in the art and there are many ways to implement a GUI and therefore, all forms of graphic input devices, including tear off menus, floating button palates, dialog boxes, alternate keyboard command and mouse short shortcuts and alternative physical input devices are all contemplated.

The document menu 406 provides options for creating and manipulating document objects within the workflow software environment. Such options may include creating a document, opening a document, closing a document, opening an ODMA interface to a document library, viewing a document in the viewer component, moving a document, printing a document and deleting a document. The ticket menu 408 provides options for creating and manipulating job/print tickets. Such options may include creating a ticket, accessing a database of tickets, viewing and setting the features/attributes controlled by a ticket, moving a ticket, deleting a ticket and associating a ticket with a document or book. The book menu 410 provides options for creating and manipulating compound document objects. Such options may include creating a book, associating or disassociating documents with a book, associating or disassociating a ticket with a book or document within a book, generating the assembled document from all of the associated component documents, generating a table of contents for the book, updating the assembled document with updates made to individual component documents, printing a book or selectively printing subsections of a book. The job menu 412 provides options for creating and manipulating jobs, which, as noted above, are documents or compound documents and associated job/print tickets. Such options may include creating a job, editing a job, moving a job, printing a job and deleting a job. The help menu 414 provides options for assisting the user with operation of the software.

The new object button 416 implements functionality to create a new document, ticket, compound document or job object and preferably, selection of this button causes a dialog box presenting various related options to be presented to the user. The open button 418 implements functionality to open an existing document, compound document, ticket, job or document library and preferably, selection of this button causes a dialog box to be presented which allows the user to locate files and manage the file system of the job preparation station 116 or network server 118. The cut button 422, copy button 424, and paste button 426 implement functionality for moving and duplicating selected objects visually displayed by the desktop component 302 as is known in the art. These buttons are coupled with a temporary storage area, also known as “clipboard” through which the cut, copy and paste functionality is implemented. The print button 428 implements the functionality of sending selected document or compound documents to the production printer device. This button preferably causes a dialog box to be displayed to the user, which acts as the interface between the desktop 302 and the print server 120 and production output devices 122. This interface may allow last minute overrides to the output options prior to final production. Preferably, this button invokes the Print File Downloader™ application manufactured by Heidelberg Digital, L.L.C., located in Rochester, N.Y. It will be appreciated that options and functions can be implemented either as a button or menu option and that the preferred workflow software can work with any arrangement. It is preferred, however, that any arrangement of buttons, menus, etc. be arranged in an ergonomic and intuitive arrangement which minimizes the operator's training time and reduces the opportunities for operator error.

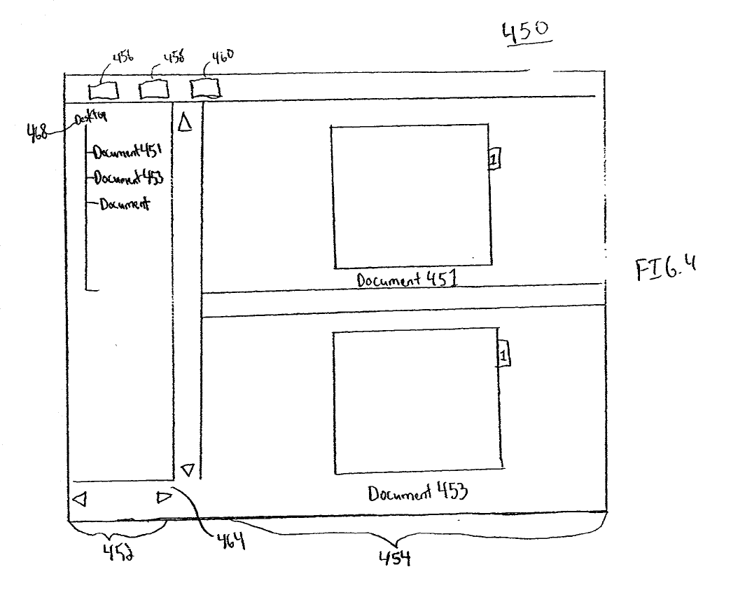

The desktop component 302 further includes a hierarchical display window 430. FIG. 4 further shows an exemplary hierarchical display window 430 showing a representative collection of objects and associations. This window 430 includes standard windowing control as are known in the art such as scroll bars 432. The window 430 further includes a representation of a hierarchy under which all of the represented objects are arranged. The exemplary window 430 includes a desktop object 442 representing the underlying database of objects, document objects 434, book objects 436 and ticket objects 438 all associated in tree structure 440. The tree structure represents the logical underlying associations between the data, which the objects 434, 436 and 438 represent. For example, the book object 436 labeled “Book 1” contains document objects 434 labeled “document 2” and “document 3”. The book object 436 labeled “Book 2” contains a ticket object 438 labeled “print settings B2” and a document object 434 labeled “Document 6” which itself contains a ticket object 438 labeled “print settings D6”. Further, the document 434 labeled “Document 1” is not associated with any other objects. In addition, objects can “expanded” or “collapsed” to show or hide their attributes or other objects lower in their hierarchy. For example, page objects representing page features specified for selected pages within a document can appear underneath the hierarchy of the specific document to visually indicate their existence to the operator. Selecting the page object permits the operator to edit, view or otherwise manipulate that page feature. A page object can exist for each page feature specified for a given document.

Further details of the graphic user interface display are provided in U.S. patnt application Ser. No. 09/572,420.

FIG. 4A, represents a GUI display 450 on a job preparation station having a display device. GUI display 450 includes a desktop component 452 and a viewer component 454. At least one document, such as document 451 and document 453 that are manipulated by the job preparation station or user is shown in a horizontal split view on viewer component 454. The documents 451 and 453 are only displayed one page at a time. The documents 451 and 453 are displayed on Acrobat with the graphical representation of the actual tabs at 9×11″ page instead of 8½×11 and the page would have text on where the regular tab of the physical media would be. The desktop component 452, includes menu 456, which allows the user to visually manage and manipulate the various objects described above. Such options may include creating a document, opening a document, closing a document, viewing a document in the viewer component, moving a document, printing a document and deleting a document. In addition, the desktop component 452 may include pop-up menus or tool buttons on the toolbars, which allow the user to modify the documents on viewer component 454.

There is a representation of an exemplary hierarchical display window 462, which includes standard windowing control as are known in the art such as scroll bars 464. The exemplary window 462 includes a desktop object 468. The desktop object represents a tree structure that includes the documents on the desktop component 454, such as documents 451 and 453. Based on the table of tabs or information associated with the table of tabs of at least one document, the actual information associated with the table of tabs of documents 451 and 453 may be manipulated by Acrobat's Thumbnail view. The user or job preparation station will select those pages that should be moved and then drag & drop these pages to their new location. In addition, there may be a plurality of information associated with the table of tabs on at least one document. The information associated with the table of tabs, which may also be known as a marker or flag.

Objects can be “expanded” or “collapsed” to show or hide their attributes for other objects lower in their hierarchy. For example, page objects representing page features specified for selected pages within a document can appear underneath the hierarchy of the specific document to visually indicate their existence to the operator. The page features may also include the color of a page, whether the page is stapled or bound or any other feature that can be associated with a page of a document.

Responsive to the marker or the information associated with the table of tabs, the job preparation station or user may decide to modify the regular tab, bleed tab or a combination thereof. If the job preparation station or user decides to modify the regular tabs, bleed tabs or a combination thereof, then the user can utilize the input device to utilize desktop component 452 or an Acrobat menu where the user can choose the documents 451 and 453 and expand it to determine where the regular tabs and/or bleed tabs are located. In addition, the job preparation station or the user may select a document by utilizing the input device to click on the document entry in the document tree on the desktop object 468 where the user can choose the documents 451 and 453 and expand it to determine where the regular tabs and/or bleed tabs are located. The utilization of the marker, enables the job preparation station or user to manipulate the menu 456 to locate the regular and bleed tabs in the document. For example, the job preparation station or user may utilize the menu 456 or use other means to expand documents 451 and 453 to display the location of the regular tabs and bleed tabs. Then the user can add, remove or edit any of the information associated with the regular and/or bleed tabs.

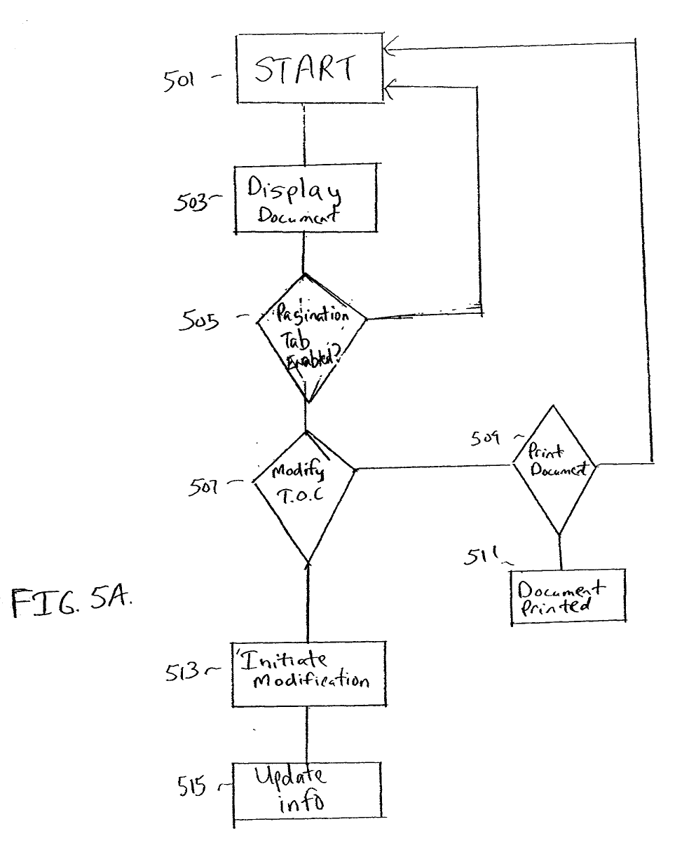

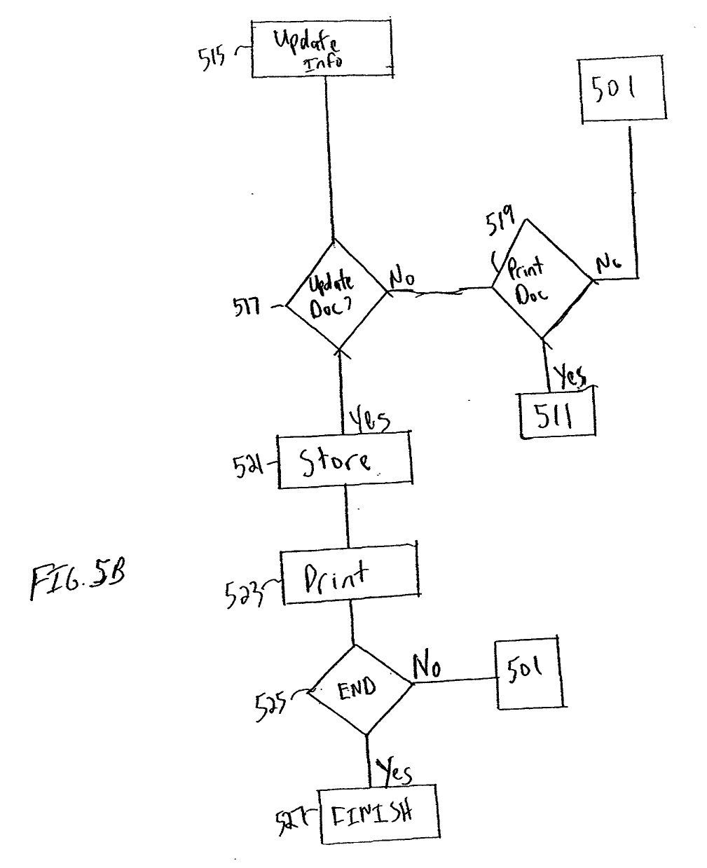

FIG. 5A, is a flow-chart representing a pagination tab process according to an embodiment of the invention. The pagination tab feature comprises the combination of regular tabs with bleed tabs within a document. In one aspect, the pagination tab feature may include one or more regular tabs or one or more bleed tabs and a combination thereof. The pagination tab feature may include other additional tabs. A “regular tab” includes a separate sheet in a document that signifies the beginning of a specific topic. A “bleed tab” includes the specific area on a page of a document where information pertaining to that page and/or document is placed. The pagination tab process is also to referred as a pagination tab software program that can be automatically started by the job preparation station 116, or manually started by a user utilizing an input device or by other means to initiate a software program. The input device can be a keyboard, mouse, touch screen, graphical user interface or any other device or method that can be utilized as an input device. The job preparation station 116 may be a separate or an integral part of an image forming process such as an electrophotographic machine, a copy machine, a facsimile or the like.

In 501, a job preparation station or a user implements the pagination tab process. The job preparation station may include a graphic user interface (GUI), an input device or the like. In 503, job preparation station may exhibit the at least one document that will be modified on viewer component 454.

In 505, the job preparation station determines if the pagination tab process is enabled. If the pagination tab process is not enabled, then the process returns to start 501. If the pagination tab process is enabled, then the job preparation station or user utilizing the input device can initiate the pagination tab process, or the pagination tab process can be initiated by any other means.

When the pagination tab process is started the job preparation station determines if the document was modified during the time when the document was last changed in Adobe Acrobat and the last time a user utilized the pagination tab software to save the document as a file. We use the timestamps to verify that a document was not modified since the user last saved it: It is possible to load a PDF file containing the markers into the retail version of Adobe Acrobat, which of course can not use or modify the markers.

Another user can. However, utilize the pagination tab software program to modify a document containing these markers in a standard Acrobat installation and can, for example, move pages around, remove pages or insert new pages from a different document. When this happens, the user has no idea what was done to the document without visiting every single page and re-scanning the document and therefore re-creating the table of tabs. Acrobat already stores a time stamp in every PDF file that gets updated when the document gets saved. In addition to this timestamp, the user utilizes the pagination tab software to store a timestamp in the file when the file is saved.

If no other user touches this file, the timestamp of when the document was last changed in Adobe Acrobat by utilizing the pagination tab software and the timestamp of the last time the user saved the document as a file by utilizing the pagination tab software will be identical when the user opens the file again. The job preparation station is able to perform this checking process by utilizing the pagination tab software program to compare a timestamp of when the document was last changed in Adobe Acrobat with the last time the user saved the document as a file. If the pagination tab software determines that the timestamp for when the document was last changed in Adobe Acrobat is equivalent or synchronized with the timestamp for when the last time the user saved the document as a file, then the pagination tab process continues with this same timestamp. Since the timestamp has not been modified, this signifies that this document includes a valid table of tabs.

The tab database or a tab media database is stored on the system level as part of the pagination tab software and is necessary to calculate the position of the tabs in a document. The tab database is available to all documents that are processed by the pagination tab software.

The tab database contains the number of tabs in any document that is inputted into the pagination tab process, and the type of tab stock that should be utilized and the location of these tabs. The tab (stock or styles) database is also the description of all tab stock that is known in a print shop. This database would e.g. contain an entry about a certain tab stock that contains three items per set with the tab cut outs on positions (x1/y1), (x2/y2) and (x3/y3) with each cutout being z long. Therefore the tab database is not updated when a document is modified, it will only be updated when a new style of tabs is first introduced in a print shop. This tab database is stored in the memory of the job preparation station in order for the job preparation station to keep an accurate account of tabs that are utilized.

The table of tabs contains specific information for each document. The table of tabs is defined as a collection of references to pages containing tabs in a table form or any applicable data structure. In the table of tabs, information regarding: the location of the tab, the type of tab that should be utilized such as a regular or bleed tab, the information to print on the regular and bleed tabs, and the location of the regular and bleed tabs is stored in the body of the PDF file within the document section of the file. This information referenced by the table of tabs is stored in the individual pages, the table of tabs only has references to these pages. For example, the table of tabs acts a pointer to a chapter in the document, which starts on a page that has some information, this information is stored only on this page.

The individual pages of the document include information pertaining to a regular tab and/or bleed tab such as a chapter number, a section number, a page number, a title, a location, at least one color, a height, a width, a vertical position, a horizontal position, a rotation, a type font, a font size and any other typical identifier information. For example, the table of tabs may include a regular tab that may be titled “Chapter 1” on a green color tab stock. In addition, the table of tabs, may include information pertaining to a bleed tab that is placed ¼ inch away from the edge of a page and 8 inches from the bottom of the page. Further, the bleed tab may also contain information such as the title “section number 2, Mathematics” typed in white letters in 12 point Arial font with a black background.

If the pagination tab software determines that the timestamp of the document that was last changed in Adobe Acrobat is different from the timestamp of the last time user saved the document as a file, then this signifies that these two timestamps are not equivalent or synchronized. If the two timestamps are not equivalent or synchronized, then this shows that another user may have utilized the pagination tab software to modify the file outside of the user's utilization of the file. Thus, only Acrobat's timestamp will be updated, the user's time stamp will still show the time the user last saved the file. So the only exception the user has to deal with is when Acrobat's timestamp is newer than the user's timestamp. If this is the case, the document is re-scanned when it is loaded again into the job preparation station. Thus, a whole new table of tabs must be created for this new timestamp document, by the job preparation station utilizing the pagination tab software program, and the pagination tab process continues.

The job preparation station goes through all of the pages of the modified document to obtain information associated with the table of tabs. The information associated with the table of tabs is stored in the individual pages of the document. The timestamp is a function utilized by the Adobe Acrobat as a way of obtaining the date and time a document was modified or utilized by the job preparation station.

In 507, the job preparation station or the user may modify the marker. The user may utilize the input device to modify the marker. If the job preparation station, decides not to modify the marker, then the process decides if the unmodified marker should be printed 509 on the at least one document. If the job preparation station or user decides not to print the unmodified marker on the at least one document, then the pagination tab process returns to start 501. If the job preparation station decides to print the unmodified marker on the at least one document, then the unmodified marker is printed 511 on the at least one document.

At 511, the user or job preparation station utilizes a print button 460, in FIG. 4, to implement the functionality of sending a selected document or compound documents to the production printer device. Since the document containing the information associated with table of tabs or marker is not modified, then the document printed will not contain any modifications to the original document. In an exemplary embodiment, the Adobe Acrobat software program is used to identify the location of the table of tabs by using a utility that works with the same application used to assemble the input (e.g. an Acrobat plug-in). This information is stored with the document. Using a utility that works with the same application used to assemble the input (e.g. an Acrobat plug-in), the regular tab and bleed tab label information is entered independent from the regular and bleed tabs order. This will normally include the text, font and orientation. This information is stored with the document. The user then invokes the Print Output Module and identifies the specific stock to use for the tabs. This identifies the order of the regular tabs and bleed tabs. This invention is by no means limited by this form of printing, this invention may utilize other applicable methods to print the document.

The document is then opened and the tab related information from all pages referenced in the table of tabs is extracted. For each tab sheet identified, the tab label information and tab location is taken based on the tab order and the tab sheet may be created as an additional page to the document. The tabs may also be printed on existing pages of the document. In addition, for each bleed tab sheet identified, the bleed tab label information and bleed tab location is taken based on the bleed tab order. If the user desires to obtain a proof set, then the amended document is sent to the printing device as a proof set document. If, after examining the proof set document, the tab order needs to be changed, the printer invokes the print output module and specifies the stock to be used for the tabs and the printer continues through the above steps until the desired output is obtained. However, if the user does not require a proof set then this proof set process is not initiated.

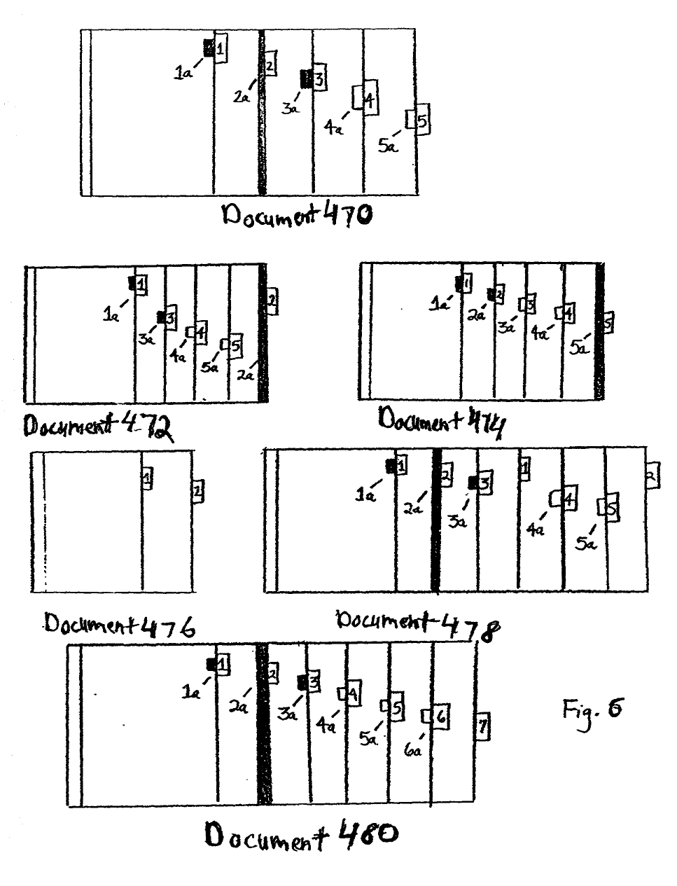

If the job preparation station or user decides to modify the marker, then the process proceeds to initiate the modification procedure 513 and the table of tabs is automatically modified. Because the job preparation station only stores references to the pages where marker information is stored in the table of tabs, it is not necessary to update information in this table when the actual marker information is updated. The table needs to be updated if a marker on a page is removed, or if a new marker is added to a page of the document. In 515, job preparation station or the user modifies the pagination tabs, which is described in FIG. 6. The user may utilize the input device to modify the pagination tabs.

In 517, the job preparation station or user decides if the document based on the changes made to the regular tabs and/or bleed tabs should be stored as an update marker on the at least one document or stored as a new marker on at least one new document or not utilize the update marker on the at least one document. If the job preparation station or user decides not to update the marker on the at least one document, then the job preparation station or user decides if the update marker on the at least one document should be printed 519. If the update marker on at least one document is not printed, then the process proceeds to start 501. If job preparation station decides to print the update marker on the at least one document, then the update marker on the at least one document is printed 511 by the same method described above.

If the job preparation station or user decides to store the update marker on the at least one document or to create a new marker on at least one new document or to create a new marker on the at least one document, then the update marker on the at least one document or a new marker on the at least one new document is stored 521. The user may formally store the update marker on the at least one document or a new marker on at least one newly created document on a disk or memory of the job preparation or any medium that has a capacity to store the information.

Responsive to the modification of the marker, a table of tabs on the individual pages of the at least one document or the at least one document may be automatically updated by the job preparation station. For example, if a tab is removed from at least one document, then the table of tabs will reflect that a tab has been deleted from the at least one document.

In addition, the actual modifications made to the document's regular and/or bleed tabs will be automatically stored as an updated marker on the at least one document's individual pages. Further, the actual modifications made to the at least one document's regular and/or bleed tabs will be automatically stored as a new marker on the individual pages of the at least one new document or as a new marker on the individual pages of the at least one document. After, the update marker on the at least one document or a new marker on at least one new document is stored, then the job preparation station or user prints the update marker on the at least one document or a new marker on at least one new document at print 523, by the printing method previously described.

In 525, the job preparation station or user decides if he wants to end the pagination tab process. If the job preparation station or user decides not to end the pagination tab process, then the process returns to start 501. If the job preparation station decides to end the pagination tab process, then the process finishes 527.

In FIG. 6, there is a visual representation of two examples of the pagination tab process. In the first example, document 470, which is an expanded transitional version of document 451, may contain five chapters 1, 2, 3, 4, and 5. Each chapter consists of pagination tabs as follows: chapter 1 consists of pagination tabs 1a on pages 2-10; chapter 2 consists of pagination tab 2a on pages 12-20; chapter 3 consists of pagination tabs 3a on pages 21-30; chapter 4 consists of pagination tabs 4a on pages 31-40; and chapter 5 consists of pagination tabs 5a on pages 41-50. In this example, the pagination tabs are a combination of regular tabs and bleed tabs, where the regular tabs are chapters 1-5 and the bleed tabs are pages 1a-5a. However, the pagination tabs, as stated, can be regular tabs or bleed tabs or a combination thereof. Those of ordinary skill in the art recognize that all of the pages in a document may not contain regular tabs, bleed tabs or a combination thereof.

The job preparation station is able to utilize desktop component 452, the Acrobat menu, or desktop object 468 to select a document, as previously described. In order to select the document, the job preparation station or user may utilize the input device to access the desktop component 452, the Acrobat menu or a document entry of the document tree of desktop object 468. In this instance, the document 451 is selected. The desktop component 452, the Acrobat menu or the desktop object expands document 451, by utilizing Acrobat's thumbnail view or ImageSmart Document Mastering SmartBoard Host” manufactured by Heidelberg Inc., Rochester, N.Y. to display the pages and the markers.

The job preparation station or user may be able to select at least one page from the selected document 451 in Acrobat's thumbnail view or from the ImageSmart Document Mastering SmartBoard Host by accessing a tab dialog. The tab dialog can be accessed by utilizing, the menu or a pop-up menu on the desktop component 452. In addition, the tab dialog can be accessed by: utilizing a tool button on Acrobat's tool bar or utilizing a tool button on the Desktop's toolbar such as an update button included on menu 456.

After the tab dialog is accessed and displayed, the job preparation station or user is able to modify or remove the regular tab and/or bleed tabs. Responsive to the marker, the job preparation station or the user is able to manipulate the desktop component 452, by accessing the tab dialog to locate the regular tabs and/or bleed tabs of document 470, which is a transitional version of document 451.

When the desktop component 452 locates the regular tabs and/or bleed tabs, then the desktop 452 or Acrobat functionality moves one or more pages to a different place in the same or in a different document. The user or job preparation station selects the pages on document 470 that should be moved and then drags & drops these pages to their new location in document 470. For example, desktop component 452 selects and moves chapter 2 to the back of document 470, where chapter 2 is subsequent to chapter 5, as shown in document 472, which is a transitional version of document 470. By selecting and moving chapter 2 to the back of the document the alignment and arrangement of the document is in disarray, as shown in document 472.

In order to fix the disarray of chapters exhibited in document 472, job preparation station automatically aligns and arranges the chapters of document 472 to form document 474, which is a transitional version of document 472. The user may utilize desktop component 452, which includes an update button (not shown) that may be included in desktop component 452 to align and arrange the regular tabs and bleed tabs of document 472 in the correct order to form document 474, which is a transitional version of document 472. By utilizing the desktop component 452, the regular tabs and bleed tabs are modified to depict chapter 2 as now being chapter 5 at the end of the document 474.

Thus, all the chapters are arranged in order, for example, chapter 1 remains chapter 1, chapter 3 becomes chapter 2, chapter 4 becomes chapter 3, chapter 5 becomes chapter 4, and chapter 5 becomes chapter 2, as shown in document 474. The job preparation station or user may store an update of the marker on the individual pages of the at least one document 470 or store a new marker on the individual pages of the at least one new document 474, as previously described. Then the update of the marker on the at least one document or the new marker on the at least one new document is printed, as previously described.

In the next example, a document 476, which is a transitional form of document 453, consists of chapters 1 and 2, which are regular tabs. This document 476 may or may not contain pagination tabs. Chapters 1 and 2 may be imported into document 470, as represented in a document 478, which is a transitional form of document 476, where chapter 1 is subsequent to chapter 3 and chapter 2 is subsequent to chapter 5. If, for example, document 476 included regular and/or bleed tabs these tabs will not be imported into document 470 to form document 478. Thus, the job preparation station will have to go through each new (imported) individual page to update the table of tabs for document 478, as previously described.

As described above, the job preparation station or the user utilizes desktop component 452, the Acrobat menu or desktop object 468, as described above, to select documents 470 and 476 and combine these documents to form document 478. In addition, the user may also utilize the input device of the desktop component 452 to combine document 470 with document 476 to form document 478.

Then the job preparation station or the user is able to select at least one page from the selected documents 470 and 476 by utilizing Acrobat's thumbnail view or the ImageSmart Document Mastering Smart Board Host, as described above. Responsive to the at least one page that is selected the job preparation station or user, as described above, is able to modify or remove the regular and/or bleed tabs.

Responsive to the marker, the job preparation station or user is able to manipulate desktop menu 452, by accessing the tab dialog to locate the regular tabs and/or bleed tabs of document 470 and document 476. When the desktop component 452 locates the regular tabs and/or bleed tabs, then the desktop 452 or Acrobat functionality moves one or more pages to a different place in the same or in a different document. The user or job preparation station select the pages on documents 470 and 476 that should be moved and then drags & drops these pages to their new location in document 478. For example, desktop 452 manually selects and moves pages containing the regular tabs and/or bleed tabs, of chapters 1 and 2 of document 476 and inserts these chapters into document 470 to form document 478. By inserting chapters 1 and 2 of document 476 into document 470, the combination of these documents form document 478 where chapter 1 is subsequent to chapter 3 and chapter 2 is subsequent to chapter 5 is misaligned and out of order.

At this point the job preparation station or user may choose to modify document 478, by utilizing desktop component 452, to modify chapter 1 that is subsequent to chapter 3 to become the new chapter 4 and modify chapter 2 that is subsequent to chapter 5 to become the new chapter 7 in document 480, which is a transitional version of document 478.

In order to fix the disarray of chapters exhibited in document 478, the job preparation station automatically aligns and arranges the chapters of document 478 to from document 480. The user may utilize an update button (not shown), which may be included in desktop component 452, to align and arrange the regular tabs and bleed tabs of document 478 in the correct order to form document 480. By utilizing the desktop component 452, the regular tabs and bleed tabs are modified to depict chapter 1 that is subsequent to chapter 3 as now being chapter 4 and depict chapter 2 that is subsequent to chapter 5 as now being chapter 7 at the end of the document 480.

Thus, all the chapters are arranged in order as follows: chapter 1 remains chapter 1, chapter 2 remains chapter 2, chapter 3 remains chapter 3, chapter 1 subsequent to chapter 3 becomes chapter 4, chapter 4 becomes chapter 5, chapter 5 becomes chapter 6, and chapter 2 that is subsequent to chapter 5 becomes chapter 7, as shown in document 480. In this way, all the chapters are aligned with their regular tabs and bleed tabs. The job preparation station may store the updated marker on individual pages of the document 470 and 476, as previously described. In addition, the job preparation station may store the updated marker as a new marker on the individual pages of the document 480, as previously described. Then the update marker on the at least one document or a new marker on the at least one new document is printed, as previously described.

The aforementioned examples do not limit the pagination tab process in any way, because this pagination tab process can modify markers contained on a multiple of documents.

It is therefore intended that the foregoing detailed description be regarded as illustrative rather than limiting, and that it be understood that it is the following claims, including all equivalents, that are intended to define the spirit and scope of this invention.

We claim:

1. A method for modifying at least one document in a printing machine having a display device, the method comprising:
determining a location of at least one marker on the at least one document;
displaying the location of the at least one marker on the display device;
modifying the at least one marker; and
generating at least one modified document in response to the modified at least one marker.

2. The method for modifying at least one document in a printing machine according to claim 1, wherein the at least one marker comprises at least one regular tab.

3. The method for modifying at least one document in a printing machine according to claim 1, wherein the at least one marker comprises at least one bleed tab.

4. The method for modifying at least one document in a printing machine according to claim 2, wherein the at least one marker comprises at least one of a type, a font size, a title, at least one color, a height, a width, a vertical position, a horizontal position, and a rotation.

5. The method for modifying at least one document in a printing machine according to claim 3, wherein the at least one marker comprises at least one of a type, a font size, a title, at least one color, a height, a width, a vertical position, a horizontal position and a rotation.

6. The method for modifying at least one document in a printing machine according to claim 1, further comprising performing an update function to modify the at least one marker.

7. The method for modifying at least one document in a printing machine according to claim 6, further comprising storing the modified at least one marker as a new marker on at least one new document.

8. The method for modifying at least one document in a printing machine according to claim 7, further comprising printing the at least one new document.

9. The method for modifying at least one document in a printing machine according to claim 1, wherein the at least one marker is comprised of a combination of at least one regular tab and at least one bleed tab.

10. The method for modifying at least one document in a printing machine according to claim 1, wherein the at least one marker is stored as objects.

11. The method for modifying at least one document in a printing machine according to claim 9, wherein said objects are page objects.

12. The method for modifying at least one document in a printing machine according to claim 9, wherein said objects comprise PDF objects.

13. The method for modifying at least one document in a printing machine according to claim 1, further comprising displaying the modification of the at least one marker on the at least one document on the display device.

14. The method for modifying at least one document in a printing machine according to claim 1, further comprising modifying a table of tabs as a response to modifying the at least one marker.

15. A method for modifying documents in a printing machine having a display device, the method comprising:
determining a location of at least one first marker on a first document;
determining a location of at least one second marker on a second document;
displaying the location of the at least one first marker and the at least one second markers on the display device;
modifying the at least one first marker and the at least one second marker to create at least one update marker; and
generating at least one modified document in response to the updated at least one marker.

16. The method for modifying documents in a printing machine according to claim 15, further comprising replacing the at least one first marker with the at least one update marker.

17. The method for modifying documents in a printing machine according to claim 15, further comprising replacing the at least one second marker with the at least one update marker.

18. The method for modifying documents in a printing machine according to claim 15, further comprising storing the at least one update marker as a new marker on a newly created document.

19. The method for modifying documents in a printing machine according to claim 15, further comprising storing the at least one updated marker as a new marker in th e second document.

20. The method for modifying documents in a printing machine according to claim 15, further comprising storing the at least one update marker as a new marker in the first document.

21. A method for modifying a plurality of documents in a printing machine having a display device, the method comprising:
determining a location of each marker in the plurality of documents;
displaying the location of each marker on the display device;
modifying each marker; and
generating a plurality of modified documents in response to each modified marker.

22. A job preparation station for a printing machine, comprising:
a job preparation station comprises a display device having a viewer component and a desktop component;
the viewer component configured to display at least one document;
the desktop component configured to determine a location of at least one marker on the at least one document;
the viewer component configured to display the location of the at least one marker;
the desktop component configured to modify the at least one marker; and
the desktop component configured to generate at least one modified document in response to the modified at least one marker.

23. The job preparation station according to claim 22, wherein the job preparation station comprises at least one input device that enables the desktop component to modify the at least one marker.

24. The job preparation station according to claim 22, wherein the display device comprises a graphic user interface.

25. The job preparation station according to claim 22, further comprising responsive to the modification of the at least one marker a table of tabs is automatically updated.

26. A printing system for printing a plurality of printing jobs, said printing system comprising:
a plurality of job preparation stations wherein at each of said job preparation stations a respective operator receives at least one document to be printed, converts the at least one document into ready for printer file format, and generates an electronic job ticket representing global document features, each job preparation station having a set of defined station attributes;
a job allocator that receives the set of defined station attributes of the job preparation stations and distributes printing jobs to a selected one of the job printing stations based on the defined station attributes of all of the job preparation stations;
the job preparations stations comprise a display device having a viewer component and a desktop component;
the viewer component configured to display at least one document;
the desktop component configured to determine a location of at least one marker on the at least one document;
the viewer component configured to display the location of the at least one marker;
the desktop component configured to modify the at least one marker;
the desktop component configured to generate at least one modified document in response to the modified at least one marker; and
an output device connected to the job preparation station, wherein the output device is operable to output the at least one modified document.

27. A printing machine, comprising:
a job preparation station;
the job preparation station operable to determine a location of at least one marker on at least one document;
the job preparation station operable to display the location of at least one marker;
the job preparation station operable to modify the at least one marker; and
the job preparation station operable to generate at least one modified document in response to the modified at least one marker.

28. The printing machine according to claim 27, further comprising an output device connected to the job preparation station the output device operable to transmit the at least one modified document.

29. A method for modifying at least one document in a printing machine having a display device, the method comprising:
determining a location of at least one marker on the at least one document in response to a table of tabs that directs the printing machine to the location of the at least one marker;
displaying the location of the at least one marker on the display device;
modifying the at least one marker; and
generating at least one modified document in response to the modified at least one marker.
